(19) United States
(12) Patent Application Publication
(10) Pub. No.: US 2003/0038087 A1
(43) Pub. Date: Feb. 27, 2003

(54) Physical separation of cells by filtration

(76) Inventor: Alex M. Garvin, Durmenach (FR)

Correspondence Address: Kevin S Lemack, Nields & Lemack, 176 E Main Street, Westboro, MA, 01581, US

(21) Appl. No.: 10/169,958

(22) PCT Filed: Jan. 19, 2001
(86) PCT No.: PCT/US01/01835

(51) Int. Cl. B01D 37/00; B01D 21/26

(52) U.S. Cl. 210/767; 210/787; 435/2

(57) ABSTRACT

Method for the selective separation of cell mixtures by filtration. A filter with well defined pores that is stable under pressure is used, and the driving force for filtration is preferably centrifugation. Cells smaller than the nominal pore size pass through the filter, while cells larger than the pores in the filter are retained.

### FIELD OF INVENTION

This invention relates to methods for separating cells based on size by filtration. In particular, this invention relates to the use of filters that have precisely defined pore sizes and whose pores are stable under pressure in order to achieve rapid and highly selective filtration of cells.

### BACKGROUND OF THE INVENTION

Biological samples often consist of mixtures of different cell types and many protocols require that a cell mixture be separated into its component parts so that a particular cell type can be analyzed in isolation. Different cell types can vary in terms of size, and these size differences provide a basis for separation. Two populations of cells differing in size can be separated using a filter that has a pore size intermediate to the 2 cell populations such that cells larger than the pores in the filter will be retained while cells smaller than the pores will pass through the filter.

Filters used to separate cells based on size must have precisely defined pores and most types of filters do not meet this criterion. For example, a standard 10 micron nitrocellulose filter excludes particles larger than 10 microns because all of the pores are less than 10 microns, but in fact pore size extends over a wide range with most of the pores being much smaller than 10 microns. Such a filter will also exclude many particles that are smaller than 10 microns because a given sub-10 micron particle can encounter a pore that is too small to pass through. A 10 micron filter of this type would not be useful for separating a 5 micron particle from a 20 micron particle, because virtually all of the 5 micron particles would be retained by the filter along with the 20 micron particles. On the other hand, such a filter would be useful for separating 20 micron particles from much smaller particles (for example 0.1 micron particles), because most pores in the filter are large enough to allow particles of such a small size to pass through.

Although cells vary in size over a wide range, cell size differences are not great enough to allow separation using a standard filter having a range of pore sizes. A filter is required that has a precisely defined pore size, such as track-etched filters. Track-etched filters are made by exposing a polycarbonate sheet to high energy radiation and then placing the sheet in an acid bath. The acid dissolves the polycarbonate in those areas weakened by radiation, leaving round holes that go straight through the sheet. Hole size can be controlled by varying the parameters of the acid bath. The pores in a 10 micron track-etched filter are all about 10 microns in diameter (mean pore size of 7.5-9.5 microns), and will allow particles slightly smaller than 10 microns to pass through the filter. Furthermore, the pores in a track-etched filter are surrounded by inflexible polycarbonate and thus are stable under pressure. A cell mixture can be forced against the filter using a syringe or by centrifugation without affecting pore size. This is not the case with filters that consist of a nylon weave mesh whose pores expand under pressure.

The following 3 examples of potential applications for separating cells based on size by filtration demonstrate the wide spead applicability of this process.

1) Vaginal swabs taken from rape victims have sperm heads 5 microns in diameter that can be separated from the victim's epithelial cells (30 microns in diameter) using a filter having a pore size somewhere between 5 and 30 microns.

2) Whole blood contains nucleated cells ranging in size from 8 to 20 microns in diameter, while the non-nucleated red blood cells have a diameter of 5 microns. Therefore nucleated and non-nucleated cells can be separated using a filter with a pore size between 5 and 8 microns.

3) Nucleated cells from whole blood contains lymphocytes that are 8 microns in diameter and non-lymphoid cells such as granulocytes and monocytes that have diameters of approximately 17 microns. Therefore lymphoid and non-lymphoid cells can be separated using a filter with a pore size between 8 and 17 microns.

Of the 3 examples listed above, the first application will be discussed in detail and data will be presented to demonstrate the validity of the process.

Sperm/Epithelial Cell Separation by Filtration

One of the most common applications of forensic DNA fingerprinting involves the analysis of DNA extracted from sperm taken from the victim of a sexual assault. Since the sperm is usually found on an epithelial cell lining, the swab used to remove the sperm often contains a large number of epithelial cells from the victim. The DNA from the victim's epithelial cell is a source of contamination and an unambiguous DNA profile of the rapist is difficult to obtain unless the DNA from epithelial cells is efficiently removed.

Epithelial cells can be preferentially lysed by preliminary incubation in an SDS/proteinase K mixture. Sperm nuclei are resistant to this treatment due to the presence of extensively cross-linked thiol-rich proteins in the sperm bead. In addition to intact epithelial cells, free nuclei from degraded epithelial cells can also be present in a sample taken from a rape victim and these free nuclei are sensitive to proteinase K/SDS digestion as well. Once digestion of the epithelial cells is complete, the sperm are pelleted and the supernatant containing the victim's DNA is discarded.

The number of sperm present in swabs taken from sexual assault victims is highly variable and is affected by a number of factors including the volume of ejaculate, the sperm count, and the time interval between the assault and the taking of the sample. The number of epithelial cells present on the swab is less variable and is not affected by the factors mentioned above. Therefore, forensics labs are confronted with swabs that vary widely in their ratios of sperm to epithelial cells.

The variation in the absolute number of sperm is usually not an issue because PCR amplification only requires a small amount of template DNA. The 1 ng of DNA required for standard micro-satellite PCR amplification, for example, is present in 600 sperm, and can be extracted from sub-microliter volumes of semen. The major problem with swabs containing relatively low numbers of sperm is not the low amount of sperm DNA that can be extracted, but rather the high ratio of victim to rapist DNA present in the initial sample. Standard selective lysis can enrich for the rapist's DNA, but when the initial ratio of epithelial cells to sperm is 100 or greater, the prepared DNA used for PCR amplification will invariably contain mostly DNA from the victim. In such cases, a completely different sperm enrichment method should be useful.

Recently, attempts have been made to separate sperm from epithelial cells by filtration, taking advantage of the size difference between these two cell types. Chen et al.(J. Forensic Science 43(1)1998 p. 114-8) describe a process for filtering a sperm/epithelial cell mixture by gravity flow through a 10 micron nylon mesh filter. 70% of the sperm and 1-2% of the epithelial cells pass through the filter. However, this approach has the limitation of requiring a very mild force to move the sperm through the filter, because the pore size of a nylon mesh will expand under pressure and allow the larger epithelial cells to pass through.

It would therefore be desirable to provide a method of sized-based separation of cells by filtration.

It would be further desirable to provide a method for selective separation of sperm cells and epithelial cells that does not suffer from the drawbacks of the prior art.

### SUMMARY OF THE INVENTION

The problems of the prior art have been overcome by the present invention, which provides a method for the selective sized-based separation of cells, such as the separation of sperm cells and epithelial cells, by filtration. A filter with well defined pores that is stable under pressure is used, and the driving force for filtration is prefererably centrifugation or pressure from a syringe. The ratio of sperm DNA to epithelial cell DNA in the final product is significantly improved using this pre-filtration step. This process can also be applied to separate other types of cell mixtures, provided that the cells populations that require separation differ in size. A multi-well format can be used to conduct multiple assays simultaneously.

### BRIEF DESCRIPTION OF THE DRAWINGS

FIG. 1a is a microscopic image of a mixture of sperm and epithelial cells prior to filtration in accordance with the present invention;

FIG. 1b is a microscopic image of a mixture of sperm and epithelial cells after filtration in accordance with the present invention;

FIG. 2a is a graph of locus D21S1435 PCR amplified from epithelial/sperm cell mixtures in a ratio of 60:1 after selective lysis;

FIG. 2b is a graph of locus D21S1435 PCR amplified from epithelial/sperm cell mixtures in a ratio of 60:1 after filtration and selective lysis;

FIG. 2c is a graph of locus D21S1435 PCR amplified from epithelial/sperm cell mixtures in a ratio of 180:1 after selective lysis;

FIG. 2d is a graph of locus D21S1435 PCR amplified from epithelial/sperm cell mixtures in a ratio of 180:1 after filtration and selective lysis;

### DETAILED DESCRIPTION OF THE INVENTION

DNA from the epithelial cells of a sexual assault victim are the source of contamination when analyzing the rapist's DNA extracted from sperm. Since sperm heads are 5 μm in diameter and epithelia are roughly 6-fold larger, it is possible to separate these two cell types by size using a filter with an intermediate pore size. The filter must have precisely defined pores that are stable under pressure so that when the mixture of cells is pressed against the filter, each sperm encounters a pore small enough to pass through and each epithelial cell is retained on the filter.

Suitable filter membranes include those having a pore size between about 4 microns and about 20 microns, such as the 5 micron Isopore filter commercially available from Millipore Corporation. The filter must be stable under pressure; that is, the pore size must remain constant or substantially constant under pressure sufficient to effectively drive the filtration, such as that exerted during centrifugation. Preferably the filters used have direct flow paths through the pores, rather than tortuous paths. Track-etched polycarbonate membranes are preferred examples of such filters. Preferably the pore size distribution of the filters are such that at least 50% of the pores have sizes differing by no more than 40% from the mean pore size, preferably by no more than 30% from the mean pore size, most preferably by no more than 20% from the mean pore size.

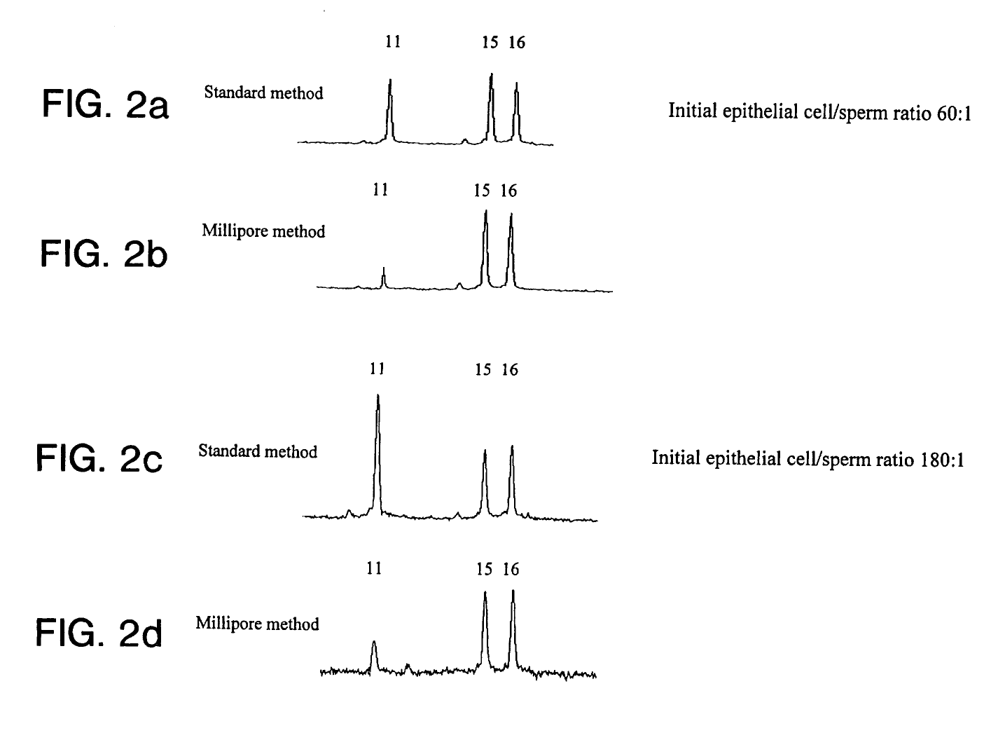

As shown in FIG. 2, pre-filtration with the Isopore filter dramatically improves the quality of the data when the initial ratio of epithelial cells to sperm is 60:1 or 180:1. When the initial ratio is 60:1, the female signal is about 50% of the male signal without filtration and less than 10% after filtration. When the initial ratio is 180:1, the female signal is dominant and the loci in which the female and male fractions share alleles would be very difficult to interpret. However, when the mixture is pre-filtered, the male signal is dominant, allowing for unambiguous profiling at all loci analyzed.

Those skilled in the art will appreciate that the foregoing example of separating sperm cells from epithelial cells is merely illustrative; other sized-based separations are within the scope of the present invention.

The filtration step of the present invention is carried out by contacting the sample containing the cells to be separated against a suitable filter, and subjecting the sample to a driving force, such as centrifugation or pressure. The cells in the sample which are larger than the pore size of the filter remain on the surface of the filter. Cells in the sample which are smaller than the pore size of the filter pass through the filter. For example, in order to separate sperm from epithelial cells that are initally present on a vaginal swab, the following protocol has proven to be successful:

Procedure

1. Agitate the swab to dislodge the sperm and epithelial cell sample in a 1.5 ml microfuge tube containing 800 μl of distilled H₂O. To recover the fluid and sample retained in the swab, gently rotate the swab against the side of the microfuge tube while removing the swab.

2. Transfer a 500 μl aliquot from step 1 to a vessel, designed for centrifugation in a microfuge, that has a 5 micron Isopore filter in its base and centrifuge at 3000 g in an Eppendorf 5415C micro centrifuge until the entire liquid phase has passed through the filter (2-7 min). The device housing the Isopore filter is identical to that used for Microcon® devices manufactured by Millipore Corporation.

In another embodiment of the present invention, multiple filtrations can be carried out simultaneously by using an array of filters. For example, conducting the filtration in a microtiter plate format will allow the processing of many samples in parallel, leading to considerable efficiencies. This has particular applicability in forensic applications, where archives of thousands of vaginal swabs can be analyzed and the results entered into databanks. A driving force such as vacuum can be used to drive the filtration. Such multiwell filtration apparatus is shown in U.S. Pat. Nos. 4,734,192 and 5,326,533, for example, the disclosures of which is herein incorporated by reference. Such apparatus includes a plate having a plurality of wells, with a membrane sealed to each well.

### EXAMPLE 1

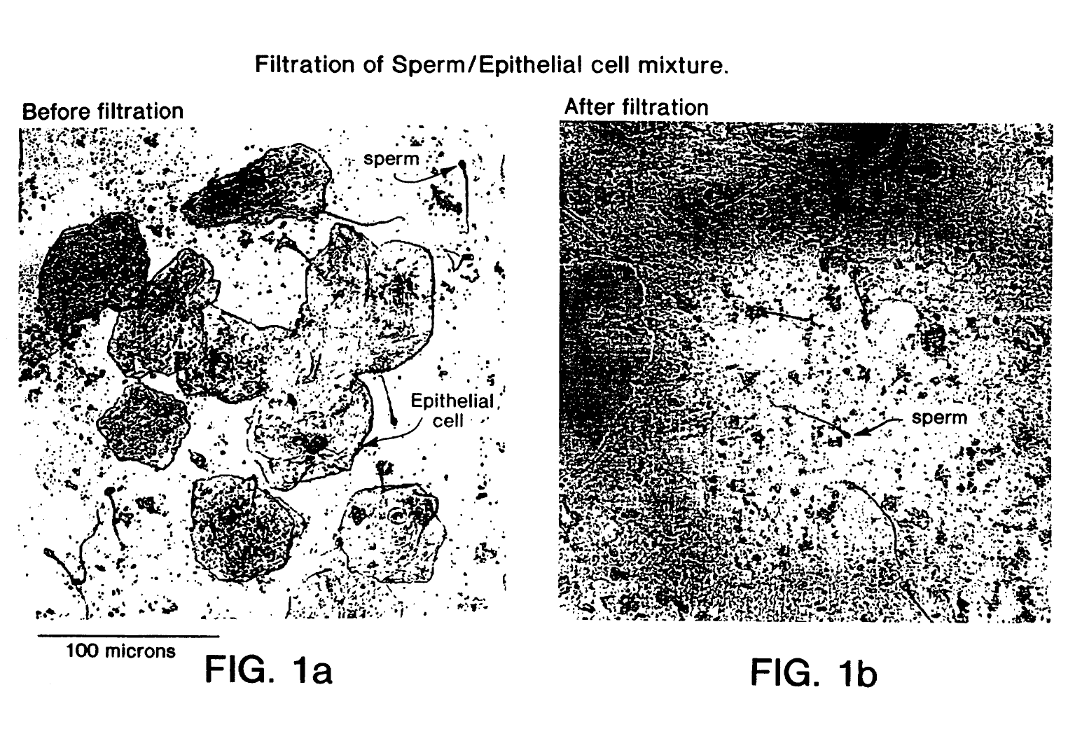

A mock forensic sample was made by mixing 100,000 epithelial cells from a bucal swab and 100,000 sperm in 500 μl of PBS and filtered through a 5 μm Isopore filter at 3000 g. A Leica DM1RB confocal microscope with differential interference at 100× amplification was used to image the cells and an image of the cells before and after filtration is presented in FIG. 1 The large nucleated epithelial cells are clearly visible in FIG. 1a along with the much smaller sperm, while in FIG. 1b only the sperm and debris smaller than 5 microns in diameter are present. This demonstrates that the 5 micron Isopore filter is very efficient in separating these two cell types even when a driving force 3000 times greater than gravitational force is used.

### EXAMPLE 2

Vaginal swabs were spiked with dilutions of sperm and allowed to sit at room temperature for 3 days in the dark. The sperm/epithelial cell ratios were determined using a hemocytometer and the resulting mixtures were either used directly for DNA preparation by selective lysis, or prefiltered with a 5 micron Isopore filter and then treated by selective lysis. DNA purified from the enriched sperm was used as template for amplification of the D21S435 microsatellite locus. Analysis of pure DNA from the female vaginal epithelial cell donor and the sperm donor indicated that the genotypes were 11 and 15/16, respectively. Therefore, the male and female fractions of DNA are easily distinguished because they have no alleles in common.

1. (Amended) A method for separating a mixture of epithelial cells and sperm cells based on size by filtration, comprising contacting a filter that has defined pore sizes and whose pores are stable under pressure, with said mixture and forcing said mixture against said filter without substantially altering said pore size, said filter having a mean pore size effective for retaining said epithelial cells while allowing said sperm cells to pass through said pores when a driving force is applied.

2. (unchanged) The method of claim 1 wherein said mixture is forced against said filter using centrifugation.

3. (unchanged) The method of claim 1 wherein said mixture is forced against said filter using pressure.

4. (unchanged) The method of claim 1 wherein the filter is a track-etched filter.

5. (unchanged) The method of claim 4, wherein said track-etched filter is polycarbonate.

6. (Amended) The method of claim 1, wherein at least 50% of said pores differ in size by no more than 40% from said mean pore size.

7. (Amended) The method of claim 1, wherein said filter has a plurality of pores which provide a direct flow path for said cells.

8. (cancelled)

9. (Amended) The method of claim 1, wherein said mean pore size of said filter is about 5 microns.

10. (Amended) The method of claim 1, wherein said driving force is centrifugation at about 3000 g.

11. (cancelled)

12. (cancelled)

13. (unchanged) The method of claim 1, wherein said method is carried out a plurality of times in parallel.

14. (Newly added) A method for separating a mixture of lymphocytes and non-lymphoid cells based on size by filtration, comprising contacting a filter that has defined pore sizes and whose pores are stable under pressure, with said mixture and forcing said mixture against said filter without substantially altering said pore size, said filter having a mean pore size effective for retaining said lymphocytes while allowing said non-lymphocytes to pass through said pores when a driving force is applied.
